(19) United States
(12) Patent Application Publication
(10) Pub. No.: US 2005/0052603 A1
(43) Pub. Date: Mar. 10, 2005

(54) In-plane switching mode liquid crystal display device and method of fabricating the same

(75) Inventor: Hyun-Suk Jin, Gyeonggi-do (KR)

Correspondence Address: MORGAN LEWIS & BOCKIUS LLP, 1111 PENNSYLVANIA AVENUE NW, WASHINGTON, DC, 20004, US

(73) Assignee: LG.PHILIPS LCD CO., LTD.

(21) Appl. No.: 10/868,027

(22) Filed: Jun. 16, 2004

(30) Foreign Application Priority Data
Sep. 5, 2003 (KR) 2003-0062017

(51) Int. Cl. G02F 1/1343

(52) U.S. Cl. 349/141

(57) ABSTRACT

An in-plane switching mode liquid crystal display device includes first and second substrates facing and spaced apart from each other, a gate line on the first substrate, a data line crossing the gate line to define a pixel region, a thin film transistor connected to the gate line and the data line, a plurality of pixel electrodes within the pixel region and connected to the thin film transistor, a plurality of common electrodes alternating with the pixel electrodes, a black matrix having an open portion on the second substrate corresponding to the pixel region, a cross-talk shielding pattern on the black matrix, the cross-talk shielding pattern having the same voltage as the plurality of common electrodes, and a liquid crystal layer between the plurality of pixel electrodes and the cross-talk shielding pattern.

The present invention claims the benefit of Korean Patent Application No. 2003-62017, filed in Korea on Sep. 5, 2003, which is hereby incorporated by reference.

### BACKGROUND OF THE INVENTION

1. Field Of The Invention

The present invention relates to a liquid crystal display (LCD) device and a method of fabricating an LCD device, and more particularly, to an In-Plane Switching (IPS) mode LCD device and a method of fabricating an IPS-LCD device.

2. Discussion of the Related Art

In general, an LCD device makes use of optical anisotropy and polarization properties of liquid crystal molecules to produce an image. The liquid crystal molecules have long thin shapes that can be aligned to have an orientation along specific directions, wherein the alignment direction of the liquid crystal molecules can be controlled by an applied electric field. Accordingly, as a direction of an applied electric field changes, the alignment of the liquid crystal molecules also changes. Due to the optical anisotropy of the liquid crystal molecules, refraction of light incident to the liquid crystal molecules is dependent upon the alignment direction of the liquid crystal molecules. Thus, by properly controlling the electric field applied to a group of liquid crystal molecules within respective pixel regions, desired images can be produced by diffracting the incident light.

There are many types LCD devices, wherein a first type of LCD device is commonly referred to an active matrix LCD (AM-LCD) device that has a matrix array of pixels, wherein each of the pixels in the AM-LCD device includes a thin film transistor (TFT) and a pixel electrode. The AM-LCD devices are currently being developed because of their high resolution and superiority in displaying moving images.

An LCD device includes a color filter substrate having a common electrode, an array substrate having a pixel electrode, and a liquid crystal layer interposed between the color filter substrate and the array substrate. In the LCD device, the liquid crystal layer is driven by a vertical electric field between the pixel electrode and the common electrode, thereby producing superior transmittance and aperture ratios. However, since the LCD device has a narrow viewing angle due to driving by the vertical electric field, various types of LCD devices having wide viewing angles, such as an IPS mode LCD device, have been developed.

FIG. 1 is a schematic cross sectional view of an IPS-LCD device according to the related art. In FIG. 1, a first substrate (i.e., an upper substrate) 10 and a second substrate (i.e., a lower substrate) 20 face and are spaced apart from each other, and a liquid crystal layer 30 is interposed therebetween. The first and second substrates 10 and 20 may be commonly referred to as a color filter substrate and an array substrate, respectively, wherein both a common electrode 22 and a pixel electrode 24 are formed on the second substrate 20 and the liquid crystal layer 30 is driven by a lateral electric field 26 between the common electrode 22 and the pixel electrode 24. Since liquid crystal molecules in the liquid crystal layer 30 change directions while maintaining their longitudinal axes in a plane perpendicular to the direct viewing direction of a display, IPS can permit a wide viewing angle for the display device. The viewing angles can range from 80 to 85 degrees along vertical and horizontal directions from a line vertical to the IPS-LCD panel, for example.

FIG. 2A is a plan view of an array substrate for an IPS-LCD device according to the related art, FIG. 2B is a plan view of a color filter substrate for an IPS-LCD device according to the related art, and FIG. 2C is a cross sectional view along IIc-IIc of FIGS. 2A and 2B, of an IPS-LCD device according to the related art. In FIG. 2A, a gate line 42 and a data line 50 crossing each other are formed on a first substrate 40, and a thin film transistor (TFT) “T” is disposed near the crossing of the gate line 42 and the data line 50. In a pixel region “P” defined by the crossing of the gate line 42 and the data line 50, a plurality of pixel electrodes 54 parallel to the data line 50 are connected to the TFT “T” via a pixel line 52. In addition, a plurality of common electrodes 46 extend from a common line 44 parallel to the gate line 42. The plurality of common electrodes 46 are parallel to the data line 50 and alternate with the plurality of pixel electrodes 54.

In the IPS-LCD device where the common electrodes 46 and the pixel electrodes 54 are formed on the same substrate, as a distance from the electrodes to the lines decreases, distortion of an electric field by the data line 50 increases. To minimize the distortion, the plurality of common electrodes 46 are arranged adjacent to the data line 50. The plurality of common electrodes 46 include a first common electrode 46a at a central portion of the pixel region “P,” and second and third common electrodes 46b and 46c at a peripheral portion of the pixel region “P” adjacent to the data line 50. The second and third common electrodes 46b and 46c have a width greater than that of the first common electrode 46a to reduce an undesired electric field between the data line 50 and the pixel electrode 54 and to prevent cross-talk due to the undesired electric field.

In FIG. 2B, a black matrix 64 having an open portion 62 in a pixel region “P” is formed on a second substrate 60, and a color filter layer 66 including red, green, and blue sub-color filters 66a, 66b, and 66c is formed on the black matrix 64. The red, green, and blue sub-color filters 66a, 66b, and 66c are alternately disposed using the black matrix 64 as a border. Since a common electrode and a pixel electrode are formed on the first substrate 40 (in FIG. 2A), the second substrate 60 does not include an additional common electrode. Although shown with respect to FIG. 2A, the black matrix 64 corresponds to the gate line 42, the data line 50, the TFT “T,” the pixel line 52, and the common line 44 of the first substrate 40. Specifically, the black matrix 64 covers a space between the data line 50 (in FIG. 2A) and the common electrode 46b and 46c (in FIG. 2A) adjacent to the data line 50 (in FIG. 2A) to prevent reduction of display quality by cross-talk.

In FIG. 2C, first and second substrates 40 and 60 face and are spaced apart from each other, wherein the first and second substrates 40 and 60 include a pixel region “P” as a minimum unit for displaying images. A plurality of common electrodes 46 spaced apart from each other are formed on the first substrate 40 in the pixel region “P.” In addition, a first insulating layer 48 is formed on the plurality of common electrodes 46, and a data line 50 is formed on the first insulating layer 48 between the adjacent pixel regions “P.” A second insulating layer 51 is formed on the data line 50, and a plurality of pixel electrodes 54 are formed on the second insulating layer 51 within the pixel region “P.” The plurality of pixel electrodes 54 alternate with the plurality of common electrodes 46, and a first orientation film 56 is formed on the plurality of pixel electrodes 54.

A black matrix 64 having an open portion 62 corresponding to the plurality of common electrodes 46 and the plurality of pixel electrodes 54 is formed on the second substrate 60. Then, a color filter layer 66 including red, green, and blue sub-color filters 66a, 66b, and 66c is formed on the black matrix 64, and an overcoat layer 68 is formed on the color filter layer 66. Next, a second orientation film 70 is formed on the overcoat layer 68, and a liquid crystal layer 80 is formed between the first and second orientation films 56 and 70.

The plurality of common electrodes 46 include first, second, and third common electrodes 46a, 46b, and 46c, wherein the second and third common electrodes 46b and 46c are disposed at both sides of the data line 50 and are spaced apart from the data line 50. The black matrix 64 corresponding to the data line 50 covers a space between the data line 50 and the common electrode 46b and 46c to overlap the second and third common electrodes 46b and 46c.

When an IPS-LCD device is driven, a lateral electric field 72 is generated between the common electrode 46 and the pixel electrode 54, and liquid crystal molecules 82 are laterally arranged along the lateral electric field 72 to obtain a wide viewing angle. A space between the pixel electrode 54 and the second common electrode 46b and between the pixel electrode 54 and the third common electrode 46c may be used for displaying images. As the lateral electric field 72 is generated between the pixel electrode 54 and the common electrode 46b and 46c, a first parasitic electric field 74 is generated between the data line 50 and the second and third common electrodes 46b and 46c. In addition, a second parasitic electric field 76 is generated between the data line 50 and the pixel electrode 54 by coupling to distort an alignment of the liquid crystal layer 80 between the pixel electrode 54 and the second and third common electrodes 46b and 46c, thereby reducing display quality due to the cross-talk.

For example, when an image having a white area and a gray area surrounding the white area is displayed, cross-talk may be calculated from transmittance (or brightness) of two portions of the gray area. In a first portion of the gray area, a first signal corresponding to a gray image is applied to a pixel electrode and a data line. In a second portion of the gray area, a first signal corresponding to a gray image is applied to a pixel electrode and a second signal corresponding to a white image is applied to a data line. Since the second signal is different from the first signal and generates a parasitic electric field with a common electrode, a first transmittance “T1” of the first portion is different from a second transmittance “T2” of the second portion. Accordingly, an amount of the cross-talk “CT” may be calculated from the following equation:
CT(%)=(|T1−T2|/T1)×100 (1)
Accordingly, as the amount of the cross-talk increases, display quality deteriorates.

FIGS. 3A and 3B are graphs showing a transmittance of an IPS-LCD device according to the related art. According to FIGS. 3A and 3B, a first signal corresponding to a gray image is applied to a pixel electrode and a second signal corresponding to a white image is applied to a data line in FIG. 3A, and a first signal corresponding to a gray image is applied to a pixel electrode and a data line in FIG. 3B. Since light is not transmitted through a black matrix and an opaque material electrode, the region corresponding to the black matrix and the electrode of an opaque material is not considered for transmittance.

In FIGS. 3A and 3B, a first transmittance (in FIG. 3A) is slightly different from a second transmittance (in FIG. 3B) due to cross-talk. Specifically, since a parasitic electric field generated in a space “III” between a data line and a pixel electrode distorts an alignment state of liquid crystal molecules, it is necessary to shield or reduce the parasitic electric field. To reduce the cross-talk, an outermost common electrode adjacent to a data line is designed to have a width greater than a width of the other common electrodes. A relationship between a width of an outermost common electrode adjacent to a data line and a cross-talk is illustrated in TABLE 1.

TABLE 1

| | Width of | Distance between | | | |
|---|---|---|---|---|---|
| | outermost | outermost | | | |
| Width of | common | common electrode | Transmittance | | |
| data line | electrode | and pixel electrode | (%) | | Cross-talk |
| (μm) | (μm) | (μm) | T1 | T2 | (%) |
| 7 | 11.5 | 11.3 | 10.29 | 10.36 | 0.69 |
| 7 | 9.1 | 12.5 | 8.95 | 9.08 | 1.41 |

In TABLE 1, a cross-talk is reduced by increasing a width of the outermost common electrode. However, as a width of the outermost common electrode increases, aperture ratio and brightness of the IPS-LCD device are reduced.

### SUMMARY OF THE INVENTION

Accordingly, the present invention is directed to an IPS-LCD device and a method of fabricating an IPS-LCD device that substantially obviates one or more of the problems due to limitations and disadvantages of the related art.

An object of the present invention is to provide an IPS-LCD device having reduced effects due to cross-talk and improved display quality.

Another object of the present invention is to provide a method of fabricating an IPS-LCD device having reduced effects due to cross-talk and improved display quality.

Additional features and advantages of the invention will be set forth in the description which follows, and in part will be apparent from the description, or may be learned by practice of the invention. These and other advantages of the invention will be realized and attained by the structure particularly pointed out in the written description and claims hereof as well as the appended drawings.

To achieve these and other advantages and in accordance with the purpose of the present invention, as embodied and broadly described, an In-Plane Switching mode liquid crystal display device includes first and second substrates facing and spaced apart from each other, a gate line on the first substrate, a data line crossing the gate line to define a pixel region, a thin film transistor connected to the gate line and the data line, a plurality of pixel electrodes within the pixel region and connected to the thin film transistor, a plurality of common electrodes alternating with the pixel electrodes, a black matrix having an open portion on the second substrate corresponding to the pixel region, a cross-talk shielding pattern on the black matrix, the cross-talk shielding pattern having the same voltage as the plurality of common electrodes, and a liquid crystal layer between the plurality of pixel electrodes and the cross-talk shielding pattern.

In another aspect, a method of fabricating an In-Plane Switching mode liquid crystal display device includes forming a gate line on a first substrate, forming a data line crossing the gate line to define a pixel region, forming a thin film transistor connected to the gate line and the data line, forming a plurality of pixel electrodes in the pixel region and connected to the thin film transistor, forming a plurality of common electrodes alternating with the pixel electrodes, forming a black matrix having an open portion on a second substrate corresponding to the pixel region, forming a cross-talk shielding pattern on the black matrix, the cross-talk shielding pattern having the same voltage as the plurality of common electrodes, attaching the first and second substrate together, and forming a liquid crystal layer between the plurality of pixel electrodes and the cross-talk shielding pattern.

In another aspect, An In-Plane Switching mode liquid crystal display device includes first and second substrates facing and spaced apart from each other, a gate line and a data line crossing on the first substrate to define a pixel region, a thin film transistor connected to the gate line and the data line, a plurality of pixel electrodes within the pixel region, a pixel line interconnecting the thin film transistor and the plurality of pixel electrodes, a plurality of common electrodes alternating with the pixel electrodes, a common line interconnecting the plurality of common electrodes, the plurality of common electrodes and common line receiving a first voltage, a black matrix having a first width on the second substrate corresponding to the pixel region, a color filter layer on the black matrix, an overcoat layer on the color filter layer, a cross-talk shielding pattern having a second width on the black matrix, the cross-talk shielding pattern receiving a second voltage similar to the first voltage and aligned with the black matrix, and a liquid crystal layer between the plurality of pixel electrodes and the cross-talk shielding pattern.

In another aspect, a method of fabricating an In-Plane Switching mode liquid crystal display device includes forming a gate line and a data line crossing each other on a first substrate to define a pixel region, forming a thin film transistor connected to the gate line and the data line, forming a plurality of pixel electrodes within the pixel region, forming a pixel line interconnecting the thin film transistor and the plurality of pixel electrodes, forming a plurality of common electrodes alternating with the pixel electrodes, forming a common line interconnecting the plurality of common electrodes, forming a black matrix having a first width on a second substrate corresponding to the pixel region, forming a color filter layer on the black matrix, forming an overcoating layer on the color filter layer, forming a cross-talk shielding pattern having a second width on the black matrix, the cross-talk shielding pattern aligned with the black matrix, attaching the first and second substrate together, and forming a liquid crystal layer between the plurality of pixel electrodes and the cross-talk shielding pattern.

It is to be understood that both the foregoing general description and the following detailed description are exemplary and explanatory and are intended to provide further explanation of the invention as claimed.

### BRIEF DESCRIPTION OF THE DRAWINGS

The accompanying drawings, which are included to provide a further understanding of the invention and are incorporated in and constitute a part of this specification, illustrate embodiments of the invention and together with the description serve to explain the principles of the invention. In the drawings:

FIG. 1 is a schematic cross sectional view of an IPS-LCD device according to the related art;

FIG. 2A is a plan view of an array substrate for an IPS-LCD device according to the related art.

FIG. 2B is a plan view of a color filter substrate for an IPS-LCD device according to the related art;

FIG. 2C is a cross sectional view along IIc-IIc of FIGS. 2A and 2B, of an IPS-LCD device according to the related art;

FIGS. 3A and 3B are graphs showing a transmittance of an IPS-LCD device according to the related art;

FIG. 4A is a schematic plan view of an exemplary array substrate for an IPS-LCD device according to the present invention;

FIG. 4B is a schematic plan view of an exemplary color filter substrate for an IPS-LCD device according to the present invention;

FIG. 4C is a schematic cross sectional view along IVc-IVc of FIGS. 4A and 4B an exemplary IPS-LCD device according to the present invention; and

FIGS. 5A and 5B are graphs showing transmittance of an exemplary IPS-LCD device according to the present invention.

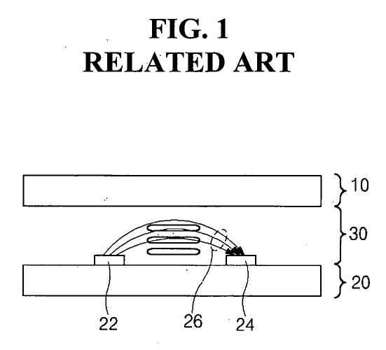

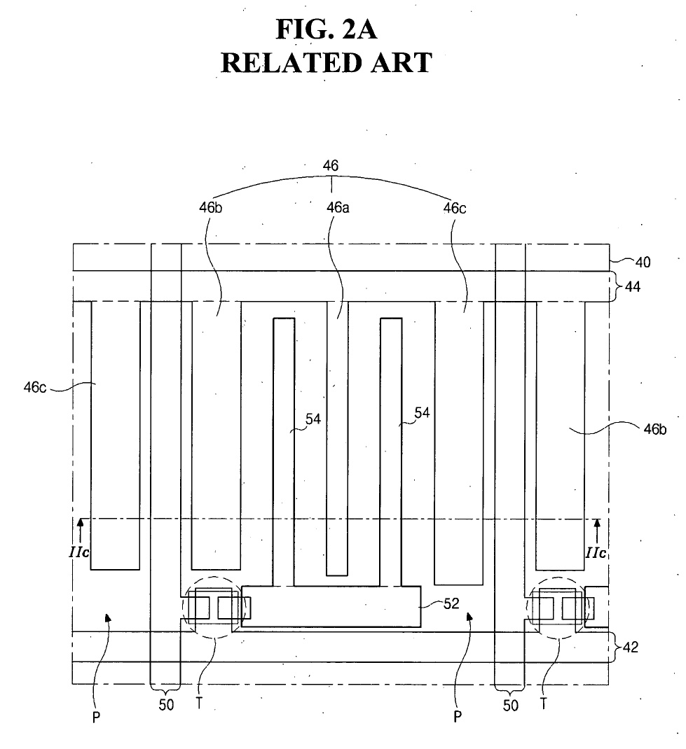

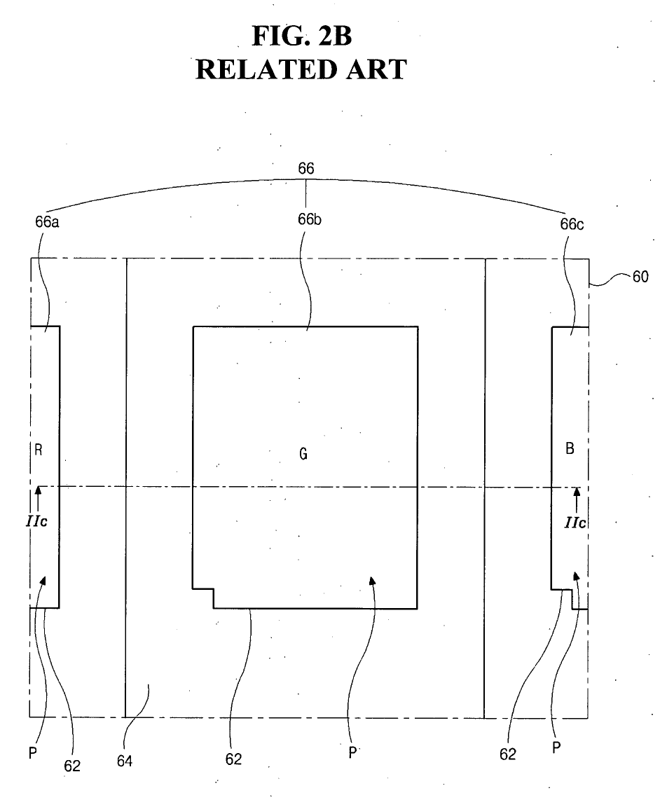

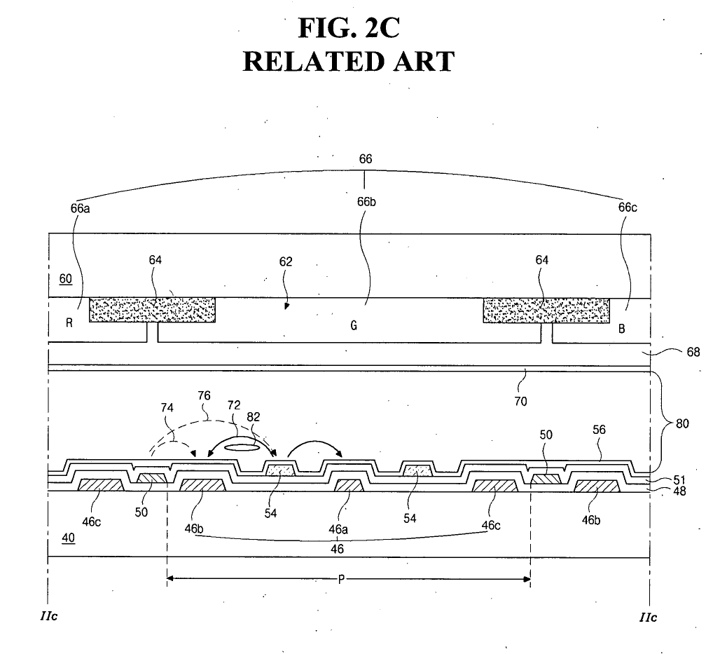

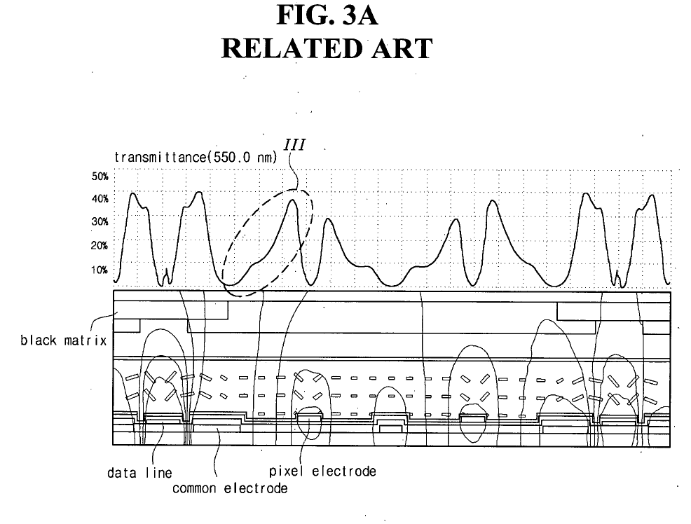

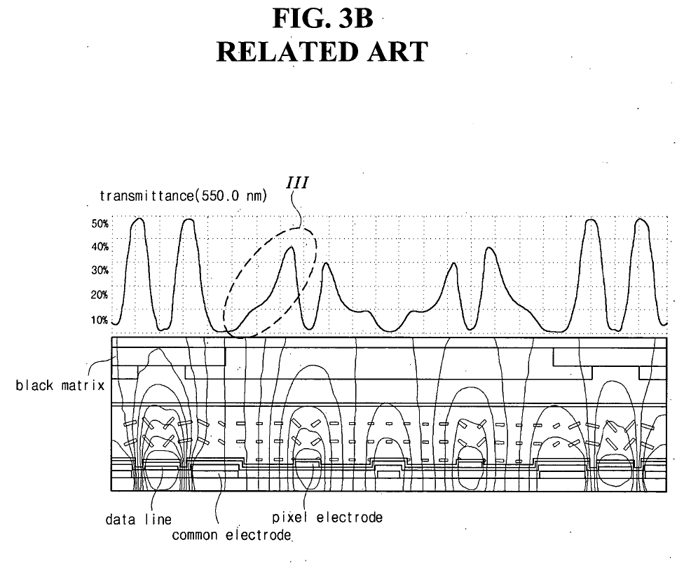

### DETAILED DESCRIPTION OF THE PREFERRED EMBODIMENTS

Reference will now be made in detail to the preferred embodiments of the present invention, an example of which is illustrated in the accompanying drawings.

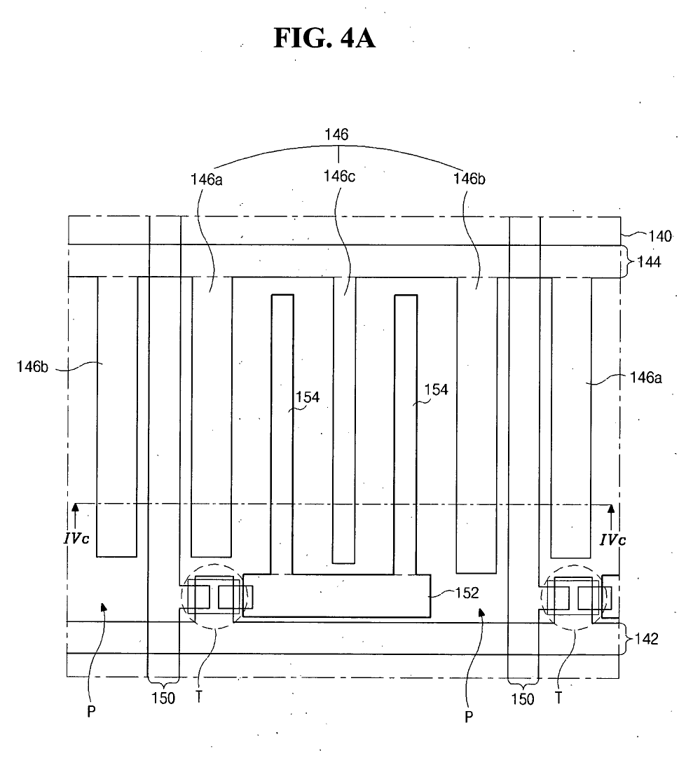

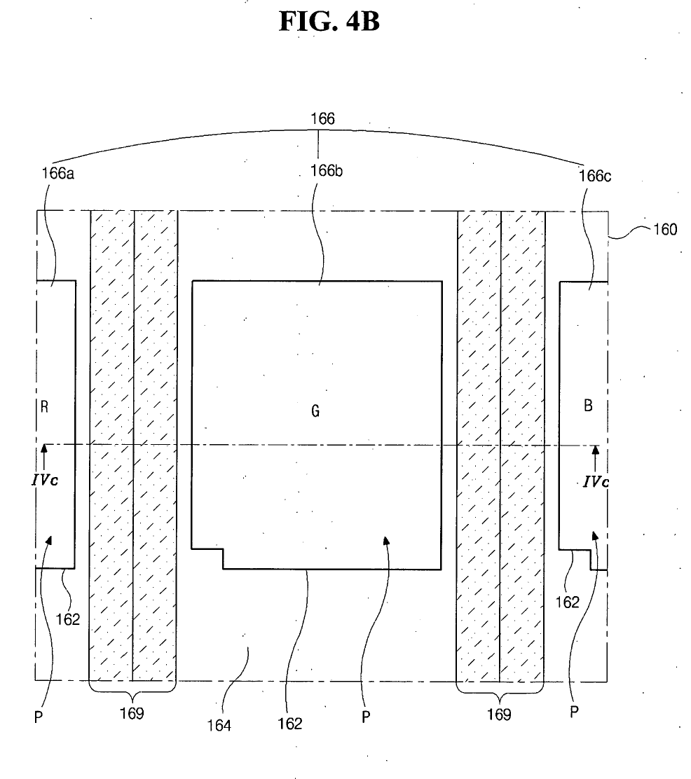

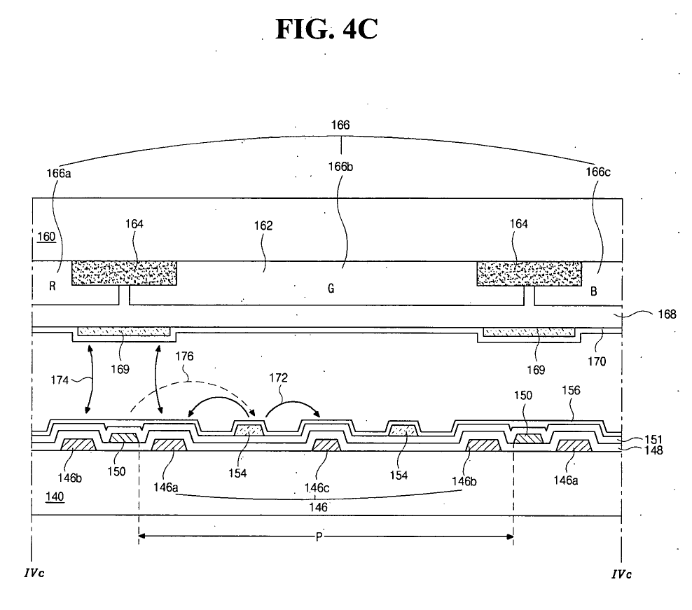

FIG. 4A is a schematic plan view of an exemplary array substrate for an IPS-LCD device according to the present invention, FIG. 4B is a schematic plan view of an exemplary color filter substrate for an IPS-LCD device according to the present invention, and FIG. 4C is a schematic cross sectional view along IVc-IVc of FIGS. 4A and 4B an exemplary IPS-LCD device according to the present invention.

In FIG. 4A, a gate line 142 may be formed on a first substrate 140 along a first direction, and a data line 150 may be formed along a second direction crossing the first direction. Accordingly, a pixel region “P” may be defined by the crossing of the gate line 142 and the data line 150, and a thin film transistor (TFT) “T” may be connected to the gate line 142 and the data line 150. In addition, a pixel line 152 may be connected to the TFT “T,” and a plurality of pixel electrodes 154 may extend from the pixel line 152 and may be formed within the pixel region “P” along the second direction. Furthermore, a common line 144 may be formed along the first direction, and a plurality of common electrodes 146 may extend from the common line 144 and may be formed within the pixel region “P” along the second direction. Thus, the plurality of common electrodes 146 may alternate with the plurality of pixel electrodes 154.

A space between the common electrode 146 and the pixel electrode 154 may correspond to an aperture region when the electrodes are formed of an opaque material. For example, four aperture regions may be defined within a single pixel region “P” by two pixel electrodes 154 and three common electrodes 146. The plurality of common electrodes 146 may include first, second, and third common electrodes 146a, 146b, and 146c, wherein the first and second common electrodes 146a and 146b may be disposed adjacent to the data line 150, and the third common electrode 146c may be disposed between the first and second common electrodes 146a and 146c. When one pixel region includes more than four aperture regions, the plurality of common electrodes may include an additional one of the third common electrode.

In order to effectively prevent cross-talk, the first and second common electrodes 146a and 146b may have a width greater than a width of the third common electrode 146c. However, since a width of the first and second common electrodes 146a and 146b may be reduced, an aperture ratio may be improved.

In FIG. 4B, a black matrix 164 having an open portion 162 may be formed on a second substrate 160, wherein the open portion 162 may correspond to the pixel region “P.” Then, a color filter layer 166 including red, green, and blue sub-color filters 166a, 166b and 166c may be alternately disposed using the black matrix 164 as a border. Next, an overcoat layer (not shown) may be formed on the color filter layer 166 and a cross-talk shielding pattern 169 may be formed on the overcoat layer. The cross-talk shielding pattern 169 may be formed to be covered with the black matrix 164 and overlap the data line 150 (in FIG. 4A) and the first and second common electrodes 146a and 146b (in FIG. 4A).

A common voltage applied to the plurality of common electrodes 146 (in FIG. 4A) may be applied to the cross-talk shielding pattern 169. Accordingly, the cross-talk shielding pattern 169 may have an equipotential with the plurality of common electrodes 146 (in FIG. 4A), and a parasitic electric field between the data line 150 (in FIG. 4A) and the pixel electrode 154 may be reduced, thereby reducing effects due to cross-talk.

In FIG. 4C, first and second substrates 140 and 160 may face and be spaced apart from each other, wherein the first and second substrates 140 and 160 may include a pixel region “P” as a minimum unit for displaying images. Then, a plurality of common electrodes 146 spaced apart from each other may be formed on the first substrate 140 within the pixel region “P.” For example, the plurality of common electrodes 146 may include first and second common electrodes 146a and 146b disposed along a boundary portion of the pixel region “P,” and a third common electrode 146c may be provided between the first and second common electrodes 146a and 146b. Next, a first insulating layer 148 may be formed on the plurality of common electrodes 146, and a data line 150 may be formed on the first insulating layer 148 between the adjacent pixel regions “P.” Then, a second insulating layer 151 may be formed on the data line 50, and a plurality of pixel electrodes 154 may be formed on the second insulating layer 151 within the pixel region “P.” Accordingly, the plurality of pixel electrodes 154 may alternate with the plurality of common electrodes 146. Then, a first orientation film 156 may be formed on the plurality of pixel electrodes 154.

In FIG. 4C, a black matrix 164 having an open portion 162 may be formed on the second substrate 160, wherein the open portion 162 may correspond to the pixel region “P. Then, a color filter layer 166 including red, green, and blue sub-color filters 166a, 166b and 166c may be formed on the black matrix 164, and an overcoat layer 168 may be formed on the color filter layer 166. Next, a cross-talk shielding pattern 169 may be formed on the overcoat layer 168, wherein the cross-talk shielding pattern 169 may correspond to the black matrix 164. Next, a second orientation film 170 may be formed on the cross-talk shielding pattern 169, and a liquid crystal layer 180 may be formed between the first and second orientation films 156 and 170.

In FIG. 4C, the cross-talk shielding pattern 169 may overlap the data line 150 and the first and second common electrodes 146a and 146b. In addition, a common voltage applied to the first, second, and third common electrodes 146a, 146b, and 146c may be applied to the cross-talk shielding pattern 169. When an IPS-LCD device is driven, a lateral electric field 172 may be generated between the common electrode 146 and the pixel electrode 154, and a parasitic electric field 176 may be generated between the data line 150 and the pixel electrode 154. However, since the cross-talk shielding pattern 169 may have the same potential (equipotential) as the common electrode 146, the parasitic electric field 176 may be reduced by the cross-talk shielding pattern 169, thereby reducing the cross-talk.

TABLE 2 shows a relationship between a width of an outermost common electrode adjacent to a data line and a cross-talk in an IPS-LCD device according to the present invention.

TABLE 2

| | Width of | Distance between | | | |
|---|---|---|---|---|---|
| | outermost | outermost | | | |
| Width of | common | common electrode | Transmittance | | |
| data line | electrode | and pixel electrode | (%) | | Cross-talk |
| (μm) | (μm) | (μm) | T1 | T2 | (%) |
| 7 | 9.1 | 12.5 | 9.51 | 9.50 | 0.17 |

In TABLE 2, cross-talk may be significantly reduced by the cross-talk shielding pattern 169 (in FIG. 4C) without reduction of aperture ratio and brightness. An amount of cross-talk “CT” may be calculated from the equation:
CT(%)=(|T1−T2|/T1)×100,
wherein T1 is a first transmittance of a first portion of a gray area and T2 is a second transmittance of a second portion of a gray area when an image having a white area and a gray area surrounding the white area is displayed. In the first portion of the gray area, a first signal corresponding to a gray image is applied to a pixel electrode and a data line. In the second portion of the gray area, a first signal corresponding to a gray image is applied to a pixel electrode and a second signal corresponding toga white image is applied to a data line.

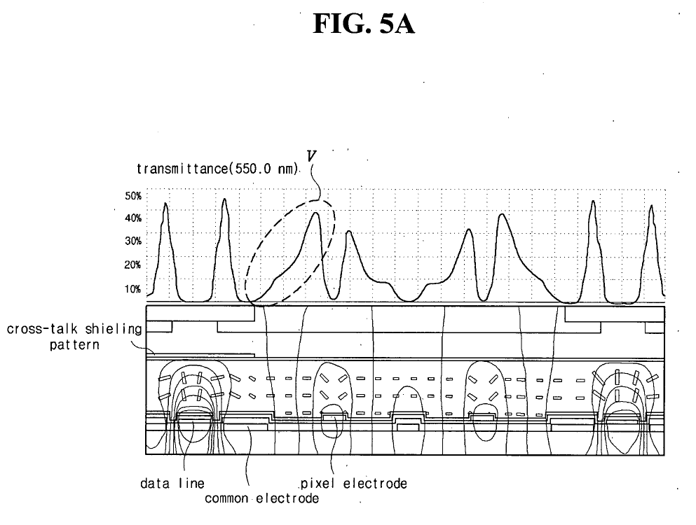

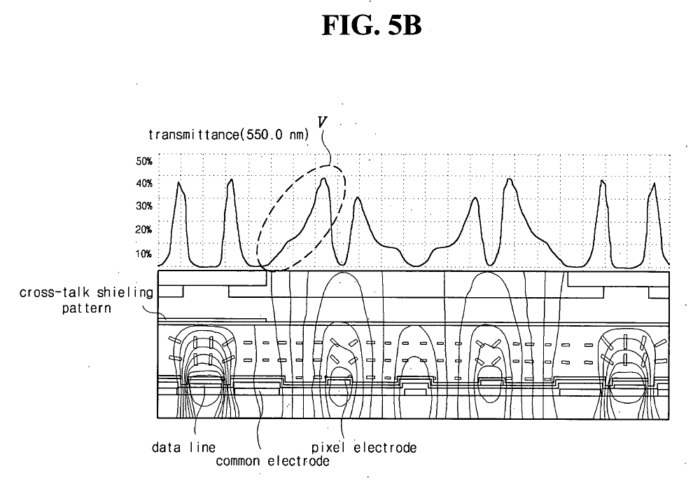

FIGS. 5A and 5B are graphs showing transmittance of an exemplary IPS-LCD device according to the present invention. According to FIGS. 5A and 5B, a first signal corresponding to a gray image may be applied to a pixel electrode, and a second signal corresponding to a white image may be applied to a data line and a first signal corresponding to a gray image is applied to a pixel electrode and a data line.

In FIGS. 5A and 5B, a first transmittance (in FIG. 5A) may be similar to a second transmittance (in FIG. 5B), and a similarity of transmittances may reduce cross-talk. Since the same common voltage may be applied to the cross-talk shielding pattern and the common electrode, a parasitic electric field between the data line and the pixel electrode may be reduced and distortion of the alignment state of liquid crystal molecules may be reduced, thereby reducing the cross-talk.

In addition, since cross-talk may be reduced by forming a cross-talk shielding pattern overlapping the data line and the common electrodes instead of increasing a width of a common electrode, an aperture ratio and a brightness may increase. Specifically, as shown in FIGS. 5A and 5B, the transmittance within a space V between a data line and a pixel electrode may increase. Moreover, as shown in TABLE 2, first and second transmittances of an IPS-LCD device may be improved when the data line and the common electrode having the same width.

According to the present invention, a cross-talk shielding pattern may be formed to overlap a data line and common electrodes adjacent to a data line, and a common voltage applied to the common electrodes may be applied to the cross-talk shielding pattern. Accordingly, a parasitic electric field between the data line and the pixel electrode may be reduced by the cross-talk shielding pattern, and cross-talk may be reduced without widening the common electrode. Moreover, since the cross-talk may be reduced by the cross-talk shielding pattern, a width of the common electrode may be reduced and aperture ratio and brightness may also be improved.

It will be apparent to those skilled in the art that various modifications and variations can be made in the IPS-LCD device and method of fabricating an IPS-LCD device of the present invention without departing from the spirit or scope of the invention. Thus, it is intended that the present invention cover the modifications and variations of this invention provided they come within the scope of the appended claims and their equivalents.

1. An in-plane switching mode liquid crystal display device, comprising:
first and second substrates facing and spaced apart from each other;
a gate line on the first substrate;
a data line crossing the gate line to define a pixel region;
a thin film transistor connected to the gate line and the data line;
a plurality of pixel electrodes within the pixel region and connected to the thin film transistor;
a plurality of common electrodes alternating with the pixel electrodes;
a black matrix having an open portion on the second substrate corresponding to the pixel region;
a cross-talk shielding pattern on the black matrix, the cross-talk shielding pattern having the same voltage as the plurality of common electrodes; and
a liquid crystal layer between the plurality of pixel electrodes and the cross-talk shielding pattern.

2. The device according to claim 1, further comprising a pixel line connecting the thin film transistor and the plurality of pixel electrodes.

3. The device according to claim 1, further comprising a common line interconnecting the plurality of common electrodes.

4. The device according to claim 1, wherein the cross-talk shielding pattern overlaps the data line and the common electrodes adjacent to the data line.

5. The device according to claim 1, wherein the cross-talk shielding pattern has the same width as the black matrix.

6. The device according to claim 1, wherein a width of the cross-talk shielding pattern is less than a width of the black matrix.

7. The device according to claim 1, wherein the plurality of common electrodes includes first and second common electrodes adjacent to the data line, and a third common electrode between the first and second common electrodes.

8. The device according to claim 7, wherein a width of the first and second common electrodes is greater than a width of the third common electrode.

9. The device according to claim 1, wherein a parasitic electric field generated between the data line and the plurality of pixel electrodes is reduced by a voltage of the cross-talk shielding pattern.

10. The device according to claim 1, further comprising a color filter layer between the black matrix and the cross-talk shielding pattern.

11. The device according to claim 10, further comprising an overcoat layer between the color filter layer and the cross-talk shielding pattern.

12. The device according to claim 11, further comprising a first orientation film between the plurality of pixel electrodes and the liquid crystal layer, and a second orientation film between the cross-talk shielding pattern and the liquid crystal layer.

13. A method of fabricating an in-plane switching mode liquid crystal display device, comprising:
forming a gate line on a first substrate;
forming a data line crossing the gate line to define a pixel region;
forming a thin film transistor connected to the gate line and the data line;
forming a plurality of pixel electrodes in the pixel region and connected to the thin film transistor;
forming a plurality of common electrodes alternating with the pixel electrodes;
forming a black matrix having an open portion on a second substrate corresponding to the pixel region;
forming a cross-talk shielding pattern on the black matrix, the cross-talk shielding pattern having the same voltage as the plurality of common electrodes;
attaching the first and second substrate together; and
forming a liquid crystal layer between the plurality of pixel electrodes and the cross-talk shielding pattern.

14. The method according to claim 13, wherein the cross-talk shielding pattern overlaps the data line and the common electrodes adjacent to the data line.

15. The method according to claim 13, wherein a parasitic electric field generated between the data line and the plurality of pixel electrodes is reduced by a voltage of the cross-talk shielding pattern.

16. An In-Plane Switching mode liquid crystal display device, comprising:
first and second substrates facing and spaced apart from each other;
a gate line and a data line crossing on the first substrate to define a pixel region;
a thin film transistor connected to the gate line and the data line;
a plurality of pixel electrodes within the pixel region;
a pixel line interconnecting the thin film transistor and the plurality of pixel electrodes;
a plurality of common electrodes alternating with the pixel electrodes;
a common line interconnecting the plurality of common electrodes, the plurality of common electrodes and common line receiving a first voltage;
a black matrix having a first width on the second substrate corresponding to the pixel region;
a color filter layer on the black matrix;
an overcoat layer on the color filter layer;
a cross-talk shielding pattern having a second width on the black matrix, the cross-talk shielding pattern receiving a second voltage similar to the first voltage and aligned with the black matrix; and
a liquid crystal layer between the plurality of pixel electrodes and the cross-talk shielding pattern.

17. The device according to claim 16, wherein the cross-talk shielding pattern overlaps the data line and the common electrodes adjacent to the data line.

18. The device according to claim 16, wherein the second width of the cross-talk shielding pattern is less than the first width of the black matrix.

19. The device according to claim 16, wherein the plurality of common electrodes includes first and second common electrodes adjacent to the data line, and a third common electrode between the first and second common electrodes.

20. The device according to claim 19, wherein a width of the first and second common electrodes is greater than a width of the third common electrode.

21. The device according to claim 16, further comprising a first orientation film between the plurality of pixel electrodes and the liquid crystal layer, and a second orientation film between the cross-talk shielding pattern and the liquid crystal layer.

22. A method of fabricating an In-Plane Switching mode liquid crystal display device, comprising:
forming a gate line and a data line crossing each other on a first substrate to define a pixel region;
forming a thin film transistor connected to the gate line and the data line;
forming a plurality of pixel electrodes within the pixel region;
forming a pixel line interconnecting the thin film transistor and the plurality of pixel electrodes;
forming a plurality of common electrodes alternating with the pixel electrodes;
forming a common line interconnecting the plurality of common electrodes;
forming a black matrix having a first width on a second substrate corresponding to the pixel region;
forming a color filter layer on the black matrix;
forming an overcoat layer on the color filter layer;
forming a cross-talk shielding pattern having a second width on the black matrix, the cross-talk shielding pattern aligned with the black matrix;
attaching the first and second substrate together; and
forming a liquid crystal layer between the plurality of pixel electrodes and the cross-talk shielding pattern.

23. The method according to claim 22, wherein the cross-talk shielding pattern overlaps the data line and the common electrodes adjacent to the data line.

24. The method according to claim 22, wherein the second width of the cross-talk shielding pattern is less than the first width of the black matrix.

25. The method according to claim 22, wherein the forming a plurality of common electrodes includes forming first and second common electrodes adjacent to the data line, and forming a third common electrode between the first and second common electrodes.

26. The method according to claim 25, wherein a width of the first and second common electrodes is greater than a width of the third common electrode.

27. The method according to claim 22, further comprising forming a first orientation film on the plurality of pixel electrodes, and forming a second orientation film on the cross-talk shielding pattern.
